(19) United States
(12) Patent Application Publication
(10) Pub. No.: US 2026/0080152 A1
(43) Pub. Date: Mar. 19, 2026

(54) SYSTEM AND METHOD FOR COMMENTARY TEXT GENERATION

(71) Applicant: ROYAL BANK OF CANADA, Toronto (CA)

(72) Inventors: Patricia AROCENA, Toronto (CA); John BOLTON, Toronto (CA); Robert HOMEWOOD, Toronto (CA); Jessica ROCK, Toronto (CA); Arshia ABDIPOUR, Toronto (CA); Prince Jayeshkumar PATEL, Toronto (CA); Tony Ming LEE, Toronto (CA); John VERMEEREN, Toronto (CA); Janice SHEEN, Toronto (CA); Balaji Chandra SEKARAN, Toronto (CA); Robin CUNNINGHAM, Toronto (CA)

(21) Appl. No.: 19/328,429

(22) Filed: Sep. 15, 2025

Related U.S. Application Data
(60) Provisional application No. 63/694,382, filed on Sep. 13, 2024.

(51) Int. Cl. G06F 40/166; G06F 3/04842; G06F 16/34; G06F 16/36; G06F 16/9532; G06F 16/9535; G06F 16/957

(52) U.S. Cl. CPC G06F 40/166; G06F 3/04842; G06F 16/345; G06F 16/374; G06F 16/9532; G06F 16/9535; G06F 16/9574

(57) ABSTRACT

There is provided a system for generating commentary documents. The system may accept attribution data as an input, and process the attribution data to display summarized attribution data in a user interface. The user may select a plurality of sectors and/or companies from said user interface. The system may execute news search queries on a benchmark and the sectors and/or companies. Topics of emphasis may be selected from the news search results. A large language model may be used to generate a commentary document based on the attribution data, the search news results, the sectors and/or companies, and the topics of emphasis.

### CROSS-REFERENCE TO RELATED APPLICATIONS

This claims the benefit of, and priority to, U.S. Provisional Patent Application No. 63/694,382 , filed Sep. 13, 2024, the entire contents of which are incorporated by reference herein.

### FIELD

This disclosure relates to the use of generative computing techniques to generate text content, and in particular to generative artificial intelligence techniques.

### BACKGROUND

In various industries, and particularly the financial industry, it is both important (and frequently legally required) to provide commentary and updates to clients to explain how an investment product has performed. Such commentary may explain, for example, what investment strategy was used, how that strategy performed (e.g., relative to a benchmark), and which factors had the most impact on performance. In addition to providing commentary to clients, such commentary may be required for other audiences, including but not limited to regulators, prospective clients, and colleagues internal to an organization.

The generation of such commentary, which provides reasons and causes for certain events, can be very time-consuming and research-intensive. For example, a common task for an employee might be writing performance commentary for a mutual fund or investment strategy. Such tasks are time-consuming and complicated, as human operators may struggle to find all relevant information and research over the relevant time period, and may not necessarily draw accurate conclusions from the information they have obtained.

The process of generating commentary is traditionally a manual process which occupies a significant amount of employee time locating and reviewing research. Moreover, such commentaries are typically required by regulations (which will vary depending on the jurisdiction of interest), and in spite of following consistent templates, may nevertheless require significant time to prepare, with a disproportionate amount of time spend assembling fund details and market data. The need for such commentaries tends to arise at specific times of year (e.g. end of quarter, semi-annually, or annually), which overconcentrates the workload on employees during short time intervals.

Accordingly, there is a need for a system which can automate or streamline the generating of commentary. This may allow employees to focus on higher-level responsibilities of their job, rather than obtaining and reviewing research. This may also improve the accuracy and/or consistency of the resulting commentary.

### SUMMARY

According to an aspect, there is provided a method comprising: receiving an electronic document containing attribution data for an entity; processing said electronic document to extract data comprising a time period and at least one of a benchmark, a sector, a company, and associated performance data; displaying, in a graphical user interface, performance data for said time period based on said extracted data; receiving a selection of at least one of said sectors and/or companies; performing, using a generative artificial intelligence system, one or more queries for news relevant to said at least one benchmark and selected sectors and/or companies; summarizing, by said generative AI system, results of said queries; displaying, in said graphical user interface, said summarized results of said queries; receiving a selection of at least one topic for emphasis; generating, by a large language model, a text document comprising commentary relating to said performance data, said benchmark, said selected sectors and/or companies, and said at least one topic for emphasis; and displaying, in said graphical user interface, said text document.

According to another aspect, there is provided a system comprising: a processor; and a computer-readable storage medium having stored thereon computer-executable instructions that, when executed by said processor, cause the processor to perform a method comprising: receiving an electronic document containing attribution data for an entity; processing said electronic document to extract data comprising a time period and at least one of a benchmark, a sector, a company, and associated performance data; displaying, in a graphical user interface, performance data for said time period based on said extracted data; receiving a selection of at least one of said sectors and/or companies; performing, using a generative artificial intelligence system, one or more queries for news relevant to said at least one benchmark and selected sectors and/or companies; summarizing, by said generative AI system, results of said queries; displaying, in said graphical user interface, said summarized results of said queries; receiving a selection of at least one topic for emphasis; generating, by a large language model, a text document comprising commentary relating to said performance data, said benchmark, said selected sectors and/or companies, and said at least one topic for emphasis; and displaying, in said graphical user interface, said text document.

According to still another aspect, there is provided a computer-readable storage medium having stored thereon computer-executable instructions that, when executed by said processor, cause the processor to perform a method comprising: receiving an electronic document containing attribution data for an entity; processing said electronic document to extract data comprising a time period and at least one of a benchmark, a sector, a company, and associated performance data; displaying, in a graphical user interface, performance data for said time period based on said extracted data; receiving a selection of at least one of said sectors and/or companies; performing, using a generative artificial intelligence system, one or more queries for news relevant to said at least one benchmark and selected sectors and/or companies; summarizing, by said generative AI system, results of said queries; displaying, in said graphical user interface, said summarized results of said queries; receiving a selection of at least one topic for emphasis; generating, by a large language model, a text document comprising commentary relating to said performance data, said benchmark, said selected sectors and/or companies, and said at least one topic for emphasis; and displaying, in said graphical user interface, said text document.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at a computing device;

FIGS. 4A and 4B depict a simplified arrangement of logical components of an example data collection, extraction and text synthesis module;

FIG. 5 depicts a simplified arrangement of components in an example data collection, extraction and text synthesis module;

FIG. 6A is an example graphical user interface allowing for an attribution table to be uploaded;

FIG. 6B is a depiction of the contents of an example attribution table;

FIG. 7 is an example graphical user interface showing the contribution of sectors to an investment product's performance;

FIG. 8 is an example graphical user interface showing the contribution of individual securities to an investment product's performance;

FIG. 9 is an example graphical user interface depicting news search results;

FIG. 10 is an example graphical user interface showing an expanded view of news search results for a market index;

FIG. 11 is an example graphical user interface showing the selection of a key driver from news search results;

FIG. 12 is an example graphical user interface showing the manual entering of a key driver, in accordance with some embodiments;

FIG. 13 is an example graphical user interface depicting an example generated commentary document, in accordance with some embodiments;

FIG. 14 is an example graphical user interface depicting a text editor having a side panel and a document pane;

FIG. 15A is an example graphical user interface depicting the operation of a linker when a cursor hovers over a key driver, in accordance with some embodiments;

FIG. 15B is an example graphical user interface depicting the operation of a linker when a cursor hovers over a text passage, in accordance with some embodiments;

FIG. 16 is an example graphical user interface depicting the operation of an expansion manager on a selected text passage;

FIG. 17A is example graphical user interface depicting the operation of a fact check orchestrator, in accordance with some embodiments;

FIG. 17B is an example graphical user interface depicting a list of claims extracted from a selected text passage by a fact check orchestrator, in accordance with some embodiments; and

FIG. 17C is an example graphical user interface depicting results of a fact checking orchestrator on the extracted claims in FIG. 17B, in accordance with some embodiments.

### DETAILED DESCRIPTION

It should be appreciated that although this disclosure contains numerous examples relating to the generation of text commentary for investment products for a financial institution, the systems and methods described herein may have applications in numerous other domains including but not limited to creating articles, research essays, legal documents, medical documents, and the like. It will be appreciated that the example embodiments described below are merely examples which serve to illuminate aspects of some embodiments of the invention, but these examples are not intended to be limiting.

Some embodiments disclosed herein may relate to a tool which may assist with fund/investment strategy performance commentary writing. For example, some embodiments may be designed to replicate the mental model of analysts, which may facilitate automation of aspects of a process which previously required significant time investment from analysts. Embodiments may be focused on 3 areas, namely 1) processing and understanding fund attribution tables, 2) gathering relevant capital market event research and security-specific news, and 3) generating an initial commentary.

In some embodiments, the understanding of a fund attribution table (FAT) may be improved by presenting notable contributors and detractors (E.g., specific stocks and/or sectors) in user-friendly, color-coded, dynamic tables. As described herein, research may be conducted using generative Artificial Intelligence (AI) techniques (e.g., agents to create reports on events impacting areas of focus selected by a user). In some embodiments, the tool may create a draft commentary in accordance with a desired structure, style and tone by combining user-selected attributes (referred to herein as “key drivers”) from research reports with performance data from the FAT and providing them to a Large Language Model (LLM). Thus, the tool may reduce the burden on human analysts and allow them to focus on higher-value tasks, such as constructing a narrative for the end reader or target audience. In some embodiments, the analyst may guide the tool through all phases of the process, acting as an assistant supporting the user through the writing process.

In some embodiments, the tool may significantly reduce the amount of time spent on manual processes. Moreover, beyond the obligation to fulfill regulatory requirements, the tool may provide improved quality in messaging for retail and/or institutional client bases, which may facilitate the maintenance and creation of new fee earning relationships for a financial institution. Systems and methods herein may further be applicable on an individual scale to provide personalized investment commentaries and experiences for individual clients.

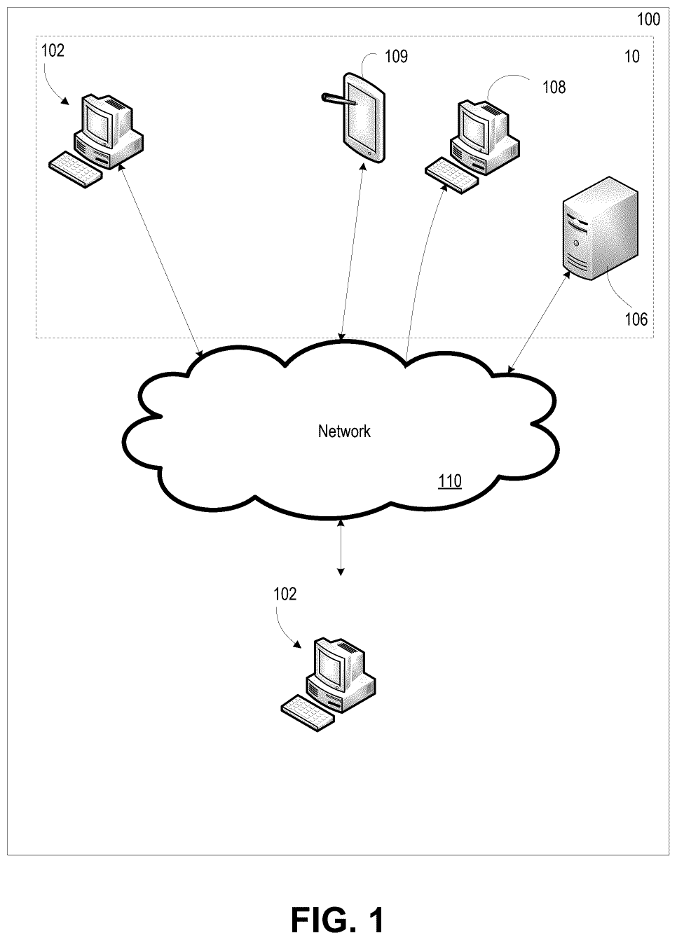

Various embodiments of the present invention may make use of interconnected computer networks and components. FIG. 1 is a block diagram depicting components of an example computing system 100. Components of the computing system are interconnected to define a data collection, extraction and text synthesis system. As used herein, the term “data collection, extraction and text synthesis system” refers to a combination of hardware devices configured under control of software and interconnections between such devices and software.

As depicted, the operating environment includes a variety of clients incorporating and/or incorporated into a variety of computing devices which may communicate with other computing devices 102 via one or more networks 110. For example, a client 102 may incorporate and/or be incorporated into client application implemented at least in part by one or more computing devices. Example computing devices may include, for example, at least one server 102 with a data storage 118 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications. In some embodiments, systems such as collection, extraction and text synthesis system 126 may be executed locally within organization 10, without requiring the extensive computing resources of external computing platforms (such as cloud services platforms).

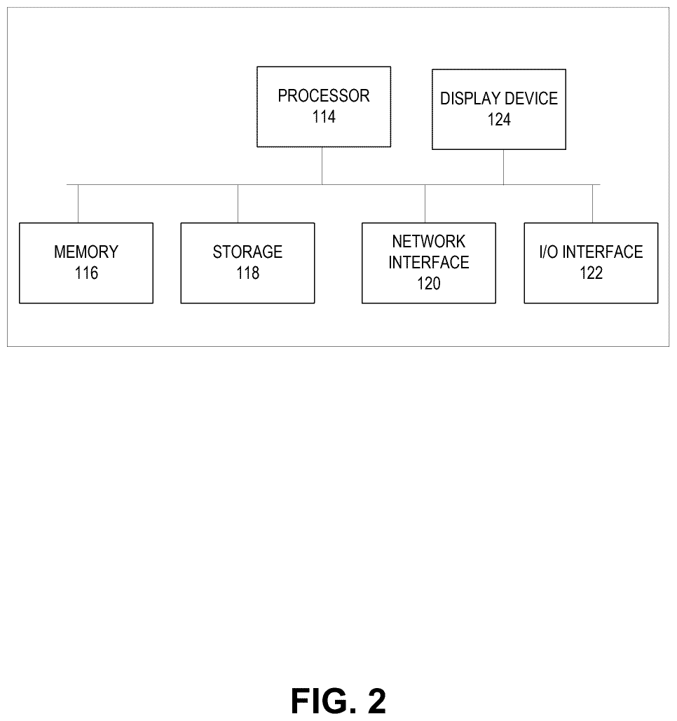

FIG. 2 is a block diagram depicting components of an example computing device, such as a desktop computing device 102, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the systems and methods described herein to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

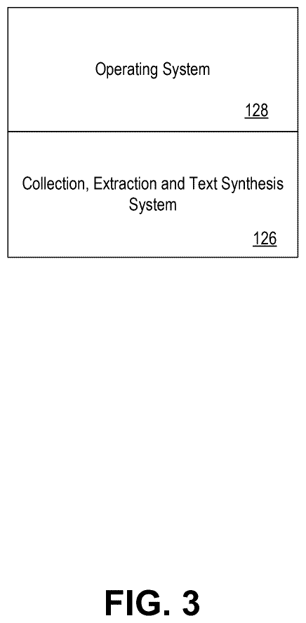

FIG. 3 depicts a simplified arrangement of software at an example computing device. The software may include an operating system 128 and application software, such as collection, extraction and text synthesis system 126. It will be appreciated that in distributed computing environments, implementation, and administration of a service such as system 126 may be distributed amongst a plurality of separate computing devices within organization 10, and FIG. 3 is intended to depict a simplified logical separation between an operating system 128 and an application executing thereon on an example computing device(s).

Some embodiments incorporate the use of Generative Artificial Intelligence (GenAI) techniques through the use of Large Language Models (LLMs) for at least one of the research phase and/or the drafting phase of the process of creating a commentary document. In some embodiments, generative AI may be used in both the research phase and the drafting phase.

Advantageously, in some embodiments, the research and drafting phases may be combined into one user workflow. For example, an agent-based generative AI system may be used to create research summaries of major market events which may have impacted an investment fund's benchmark index, and/or specific companies of interest included in the fund. In some embodiments, the specific companies may be selected by the user. In still further embodiments, the system may allow the user to select “key drivers” (or more broadly, concepts which are selected to receive heightened emphasis) from these research summaries, and these key drivers may be merged with the investment fund's performance data prior to providing the data to an LLM. This may allow for the text synthesis tool to generate fund commentaries in which event research is more closely linked with the fund's performance data. The resulting output may, therefore, more closely mimic written commentaries from a human analyst in which news and performance data are interweaved in order to create a cohesive narrative.

In some embodiments, the tool may allow the user to directly control what information is included in the generated commentary text. For example, after uploading a fund's attribution table, a user may select which sectors and/or companies the generated text commentary should emphasize. During the research phase, the above-noted key drivers may be determined and/or selected by the user. In some embodiments, the key drivers may be selected by the user by highlighting phases of interest in generated news summaries. In other embodiments, the user may manually enter a key driver. Allowing the user to directly select areas of emphasis may result in generated commentaries which are highly customizable. Advantageously, the ability to manually enter a key driver may allow for a high-level narrative for generated commentary to be input prior to beginning the text generating phases. Thus, a user who has a narrative in mind based on their knowledge of a fund and surrounding events impacting the fund's holdings may be able to steer the generation of commentary in a desired direction.

In some embodiments, systems and methods disclosed herein may include translating performance data (e.g. from fund attribution tables) into a format which may be properly understood by an LLM, which may lead to significant improvements in the quality of generated commentary. In some embodiments, although all performance data may be extracted, only a subset might be passed through to commentary generation. In some embodiments, a set of definitions of performance valued may be provided to assist the LLM in understanding how to interpret various values and incorporate them into the resulting commentary draft. In some embodiments, some specific numerical values may be translated into a text representation to improve the reliability of the generated text and reduce possible hallucinations, as described below.

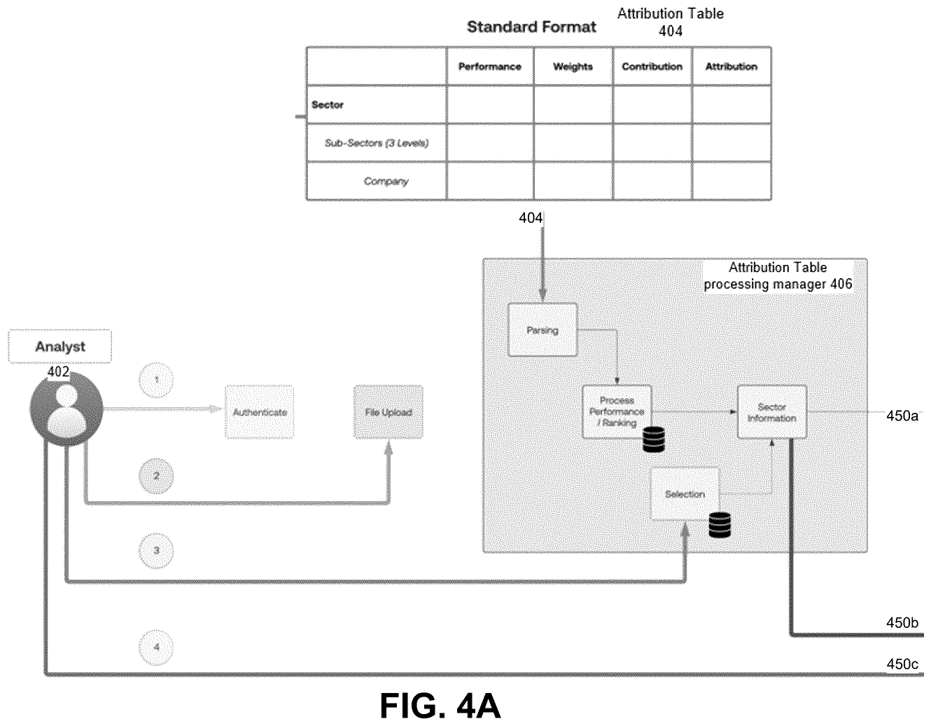

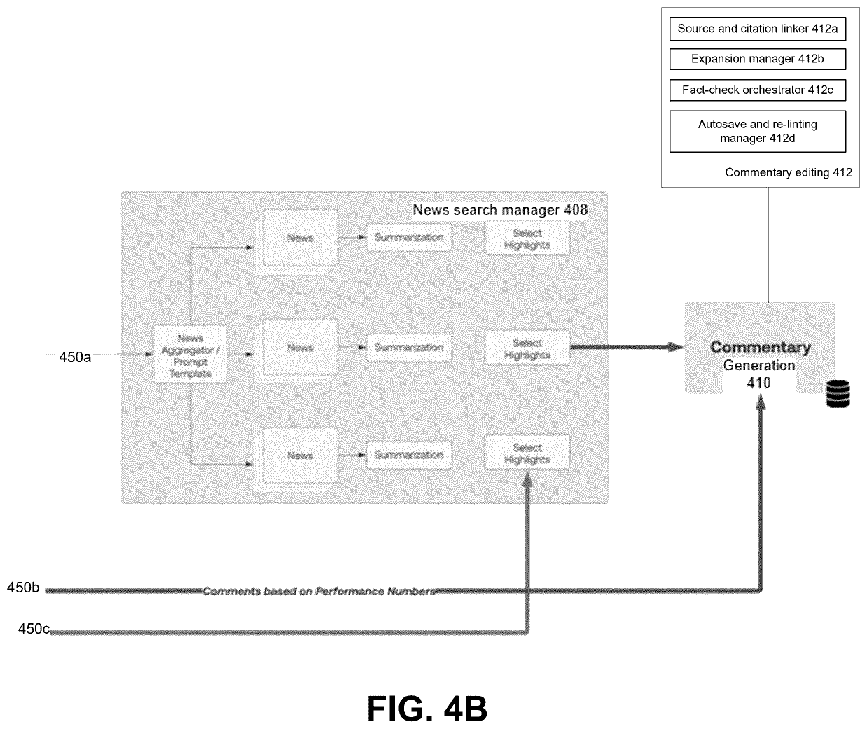

FIGS. 4A and 4B depict a simplified arrangement of high-level logical system components of a system that performs data collection, extraction, and text generation processes 400 which may be used to generate commentary, in accordance with some embodiments.

As depicted in FIG. 4A, at block 1, an analyst (or user) 402 may log into the system and satisfy the necessary authentication requirements. Such authentication may include one or more of the entry of a username, password, possibly biometric data (e.g. a thumbprint or face recognition), and/or the use of multi-factor authentication, as is known to those skilled in the art.

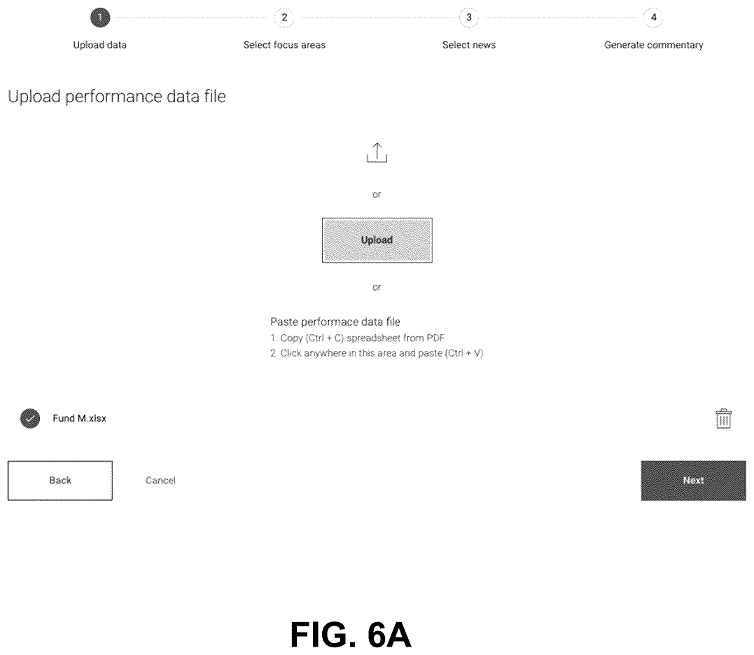

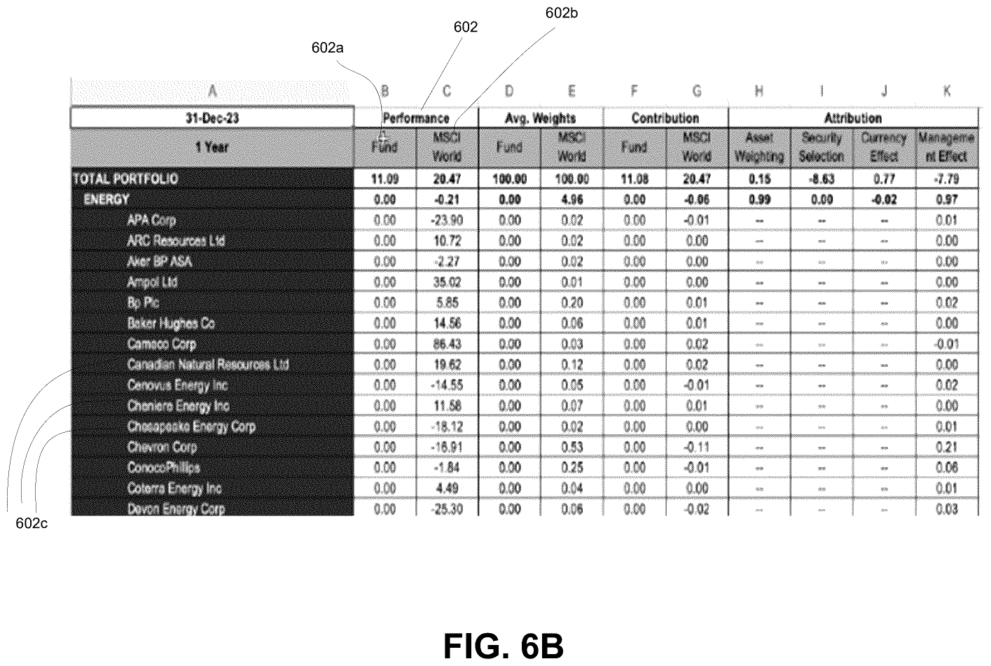

At block 2, the analyst may upload a file. In some embodiments, the file is an attribution table 404. An attribution table may, for example, provide a breakdown of one or more of the performance of an investment vehicle relative to a benchmark (e.g. an index, such as the Toronto Stock Exchange (TSX), S&P 500, and the like), the contribution of individual assets or sectors 602c to the investment product's overall performance, and the contribution of an advisor's decision-making to the overall performance. FIG. 6A is a depiction of an example interface which might be presented to user 402 to facilitate uploading of an attribution table. As depicted, the attribution table 404 is “Fund M.xlsx”. It should be appreciated that an attribution table may be in many different possible file formats, and that a Microsoft Excel spreadsheet file is merely an example.

In some embodiments, attribution tables are in the form of spreadsheets or charts which contain numerical data representing various metrics. FIG. 6B is a depiction of the contents of an example attribution table 404. As depicted, data provided in the example attribution table includes a performance delta 602 (i.e. the performance of the fund 602a relative to a benchmark index 602b (e.g., the TSX, S&P 500, MSCI World indeces, or the like), an average weights delta (i.e. a difference in weighting of fund constituents relative to the benchmark index), a contribution delta (i.e. a difference in the contribution of a constituent asset to the overall performance of the fund, relative to that constituent asset's contribution to the benchmark index), an attribution asset weighting, a security selection, a currency effect, and a management effect score (i.e. a measurement of the effect of a decision-maker's (e.g., a fund manager) decisions on the performance of the fund relative to the performance of benchmark index.

For example, as depicted in FIG. 6B, the decision-maker may have chosen to include a lower weighting of the energy sector (e.g. a weighting of 0, relative to a weighting of 4.96 in the benchmark index). Since the energy sector performed negatively (as depicted by the −0.21 score), the management effect is listed as a positive number (0.97), as the decision to deviate from the benchmark weighting by the decision-maker resulted in the investment product holding fewer securities which had negative performance. It will be appreciated that the example depicted in FIG. 6B depicts merely a snippet of what will typically be a vast spreadsheet with tens of thousands of entries, and that, aside from the names of sectors and the names of individual companies/securities, virtually all other entries in the attribution table will contain numerical values.

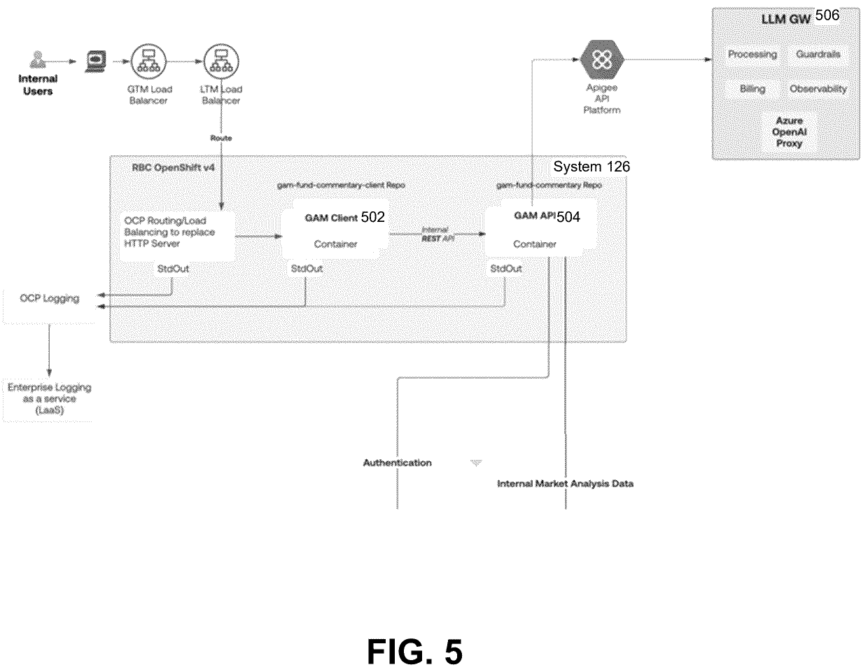

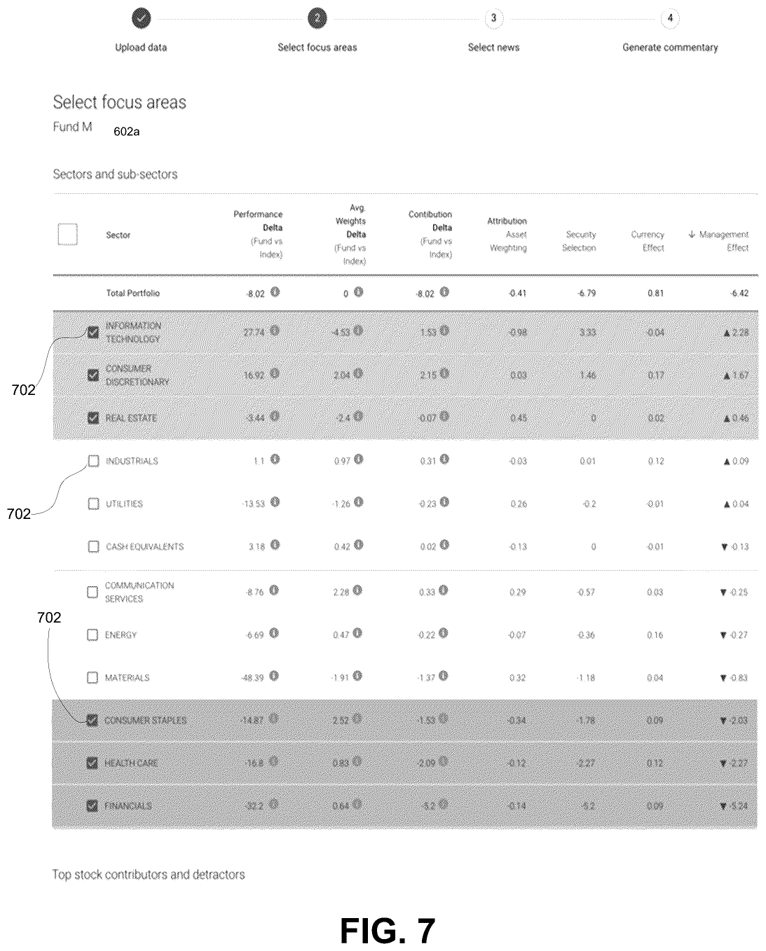

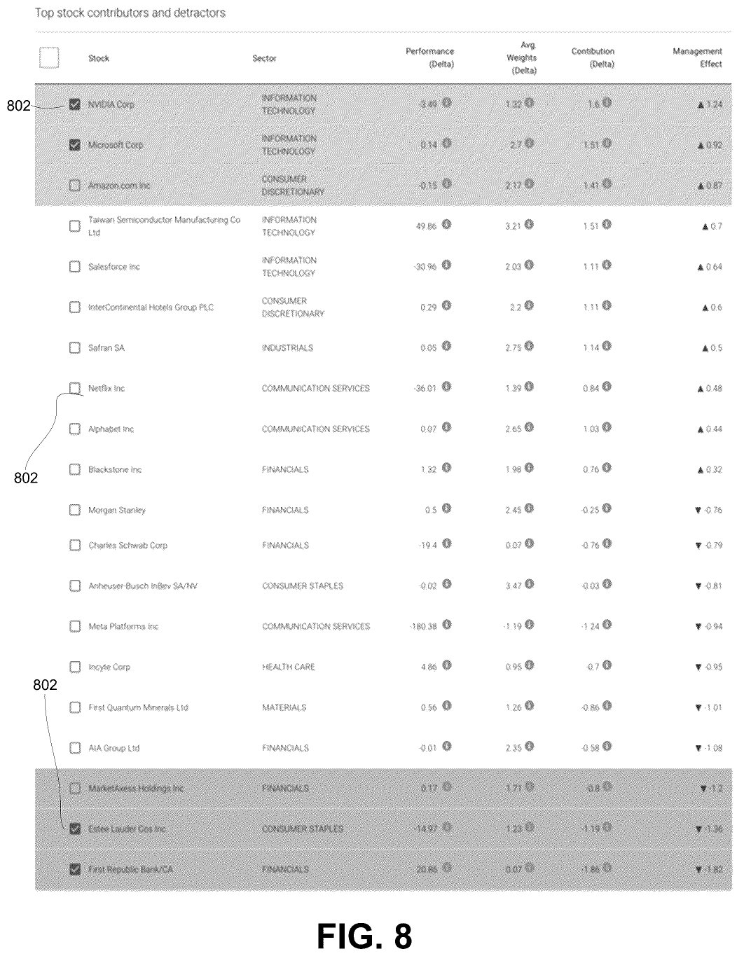

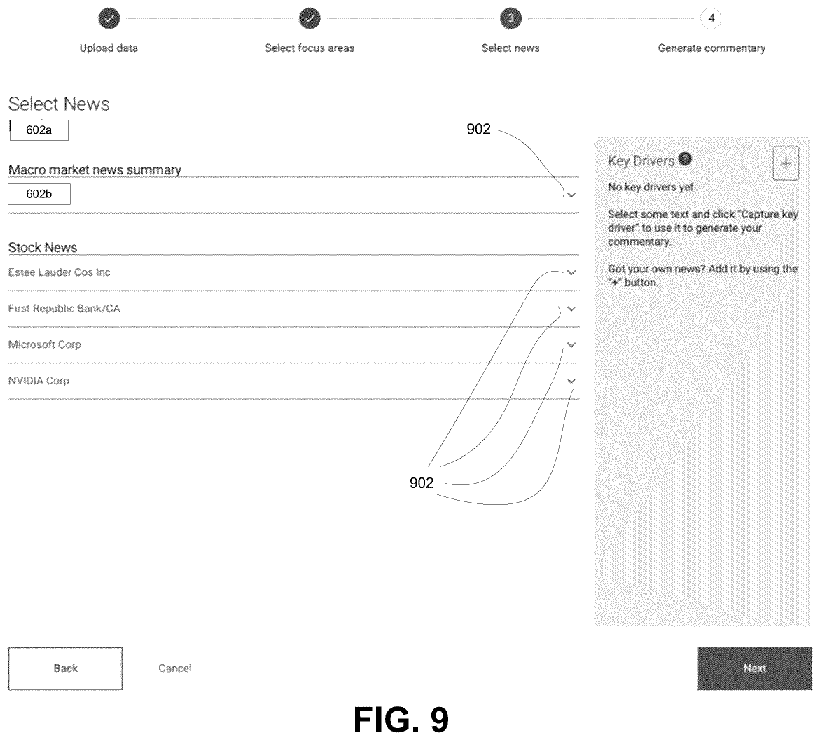

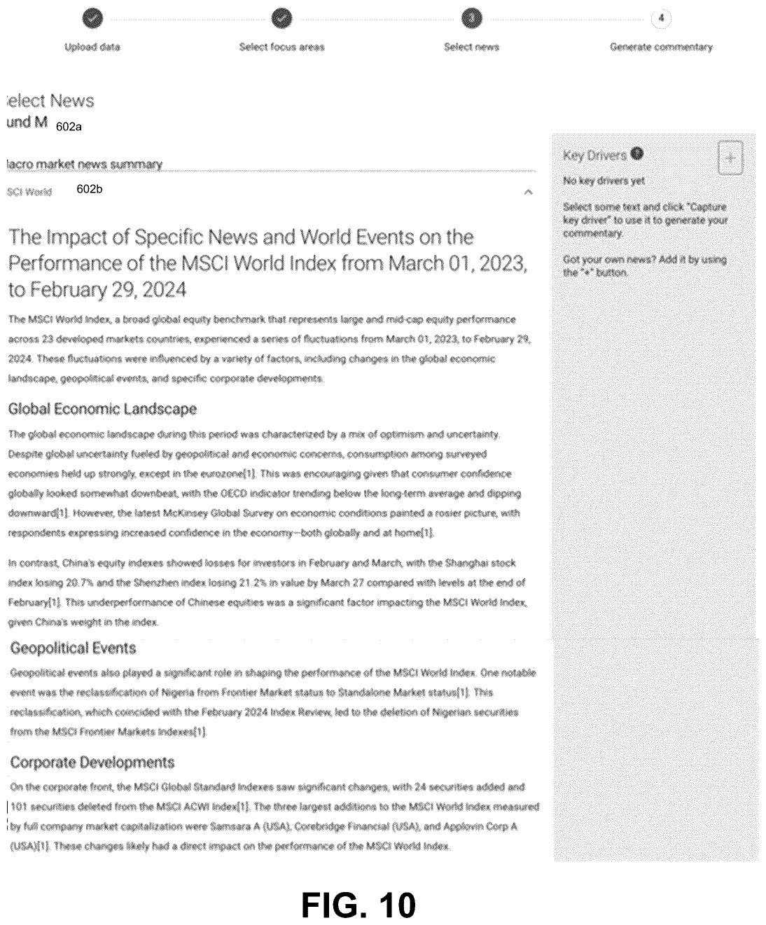

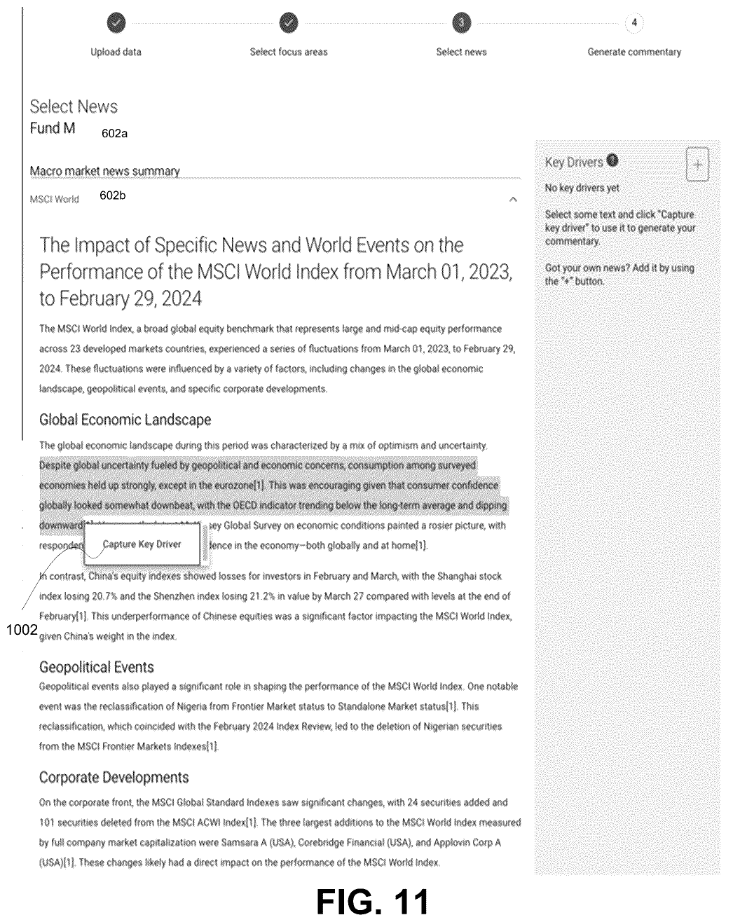

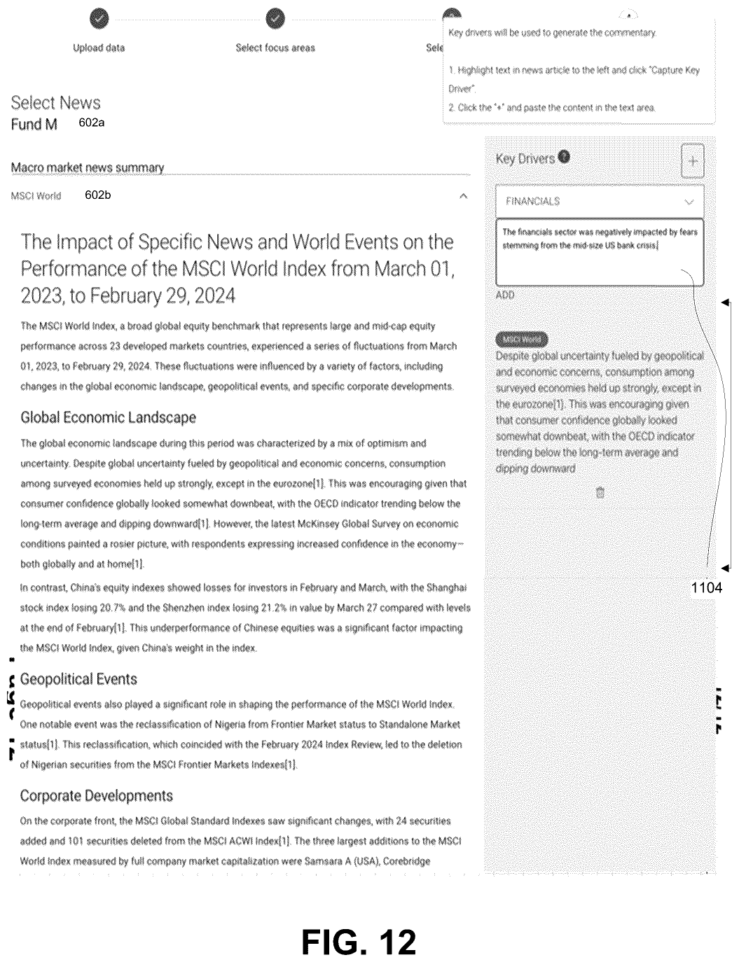

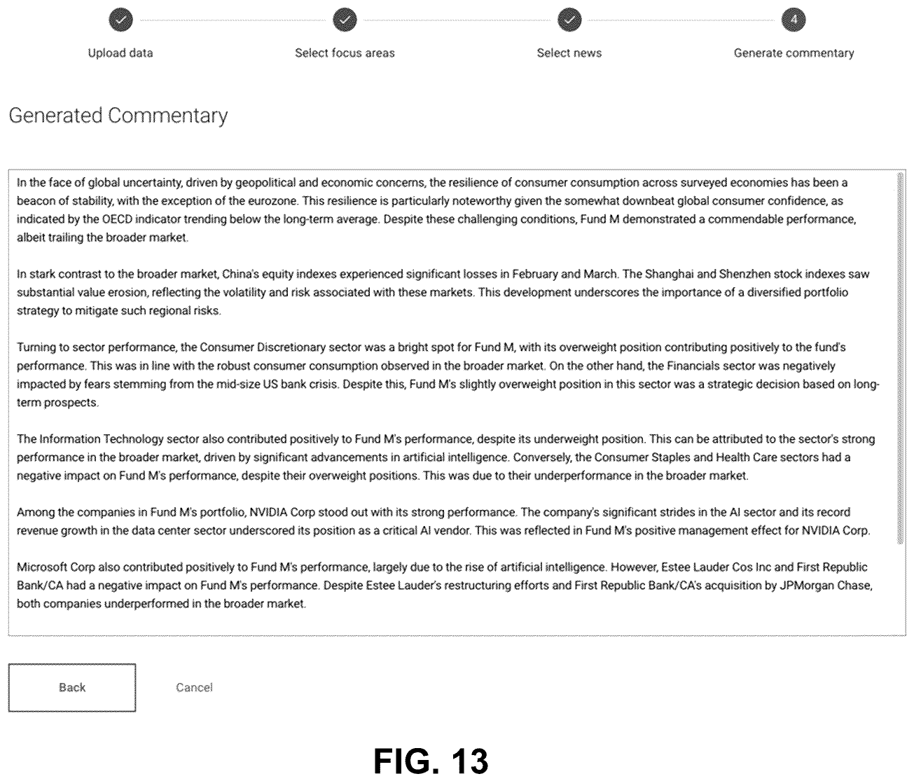

FIG. 5 depicts an example system diagram of data collection, extraction, and text synthesis system 126. As depicted, system 126 may include a backend Application Programming Interface (API) 504, and a front-end web client 502. In some embodiments, the API may be a FastAPI Python API. In some embodiments, the front-end web client may be a React-based front-end web client using JavaScript. In some embodiments, the front-end web client may include components defined for each main page (e.g. the ‘file upload’ page depicted in FIG. 6A, the ‘select focus areas’ pages depicted in FIGS. 7-8, the ‘news search’ pages depicted in FIGS. 9 and 10, the ‘key driver’ selection pages depicted in FIGS. 11 and 12, and the commentary generation pages depicted in FIG. 13). In some embodiments, the front end client 502 may communicate with API 504 via one or more of GET, PATCH, and POST requests. In some embodiments, Server Sent Events may be used during the news search process to provide real-time feedback to the user 402 as the system conducts searches and generates summaries. The system 126 may incorporate the use of databases for storing data required to generate commentary. In some embodiments, the API 504 may make use of an SQLite database.

In some embodiments, the backend API 504 may include a configuration file which defines the API routes, as well as three manager modules which perform distinct functions. In some embodiments, the three manager modules may include a manger 406 for parsing the attribution table, a manager 408 for performing data collection (e.g. searching for news), and a manager for communicating with a large language model (LLM) through a gateway. In some embodiments, the data collection manager may use a modified version of the open-source framework GPT Researcher to generate news summaries.

In some embodiments, data classes may be defined in a file (e.g., a Python script). In some embodiments, the SQLite database may include data classes for one or more of:
GeneratedCommentary: The overarching commentary (date range, baseline name, fund name, and the like)
Sector: An individual sector (name, use in the commentary, rank by management effect)
Subsector: An individual subsector
Company: Data about an individual company or security
PerformanceData: the performance of a sector, sub-sector, company/security, or overall fund
NewsItem: a generated news summary for a company or the market
NewsHighlight: a news highlight (or key driver) created by the user 404.

In some embodiments, when attribution table 404 is uploaded by user 402 via front end client 502, the attribution table 404 may be parsed into the above-mentioned data classes and stored in a database by attribution table processing manager 406. In some embodiments, the attribution table may be parsed into GeneratedCommentary, Sector, Subsector, Company, and PerformanceData classes.

In some embodiments, the processing of attribution table 404 may include the transformation of at least some of the numerical and/or mathematical language in the attribution table 404 into natural language which is more easily consumed and understood by a large language model (LLM). In some embodiments, attribution table processing manager 406 may determine the relevant time period based on date ranges includes in the attribution table.

Once the attribution table has been converted and stored, the attribution table processing manager may pass data to the front-end, which may generate various graphical user interfaces which present information to the user 402 in a more simplified format.

For example, FIG. 7 provides an example user interface which depicts processed contents of attribution table 404. As depicted, data from attribution table 404 has been transformed into data which is sector-specific. For example, as depicted, the example sectors include information technology, consumer discretionary, real estate, industrials, utilities, cash equivalents, communication services, energy, materials, consumer staples, healthcare, and financials. For each sector, there is displayed a performance delta, an average weights delta, a contribution delta, an attribution weighting, a security selection metric, a currency effect metric, and a management effect score.

It will be appreciated that in FIG. 7, the sector-specific data has been sorted based on the management effect score for each sector (which may represent the effect of the decision-making of the fund manager, and identify top contributors and detractors).

FIG. 8 provides a further example user interface which depicts processed contents of attribution table 404. As depicted in FIG. 8, data from attribution table 404 has been presented in a manner which is company (or security) specific. For each listed company, there is provided an associated sector, performance delta, average weight delta, contribution delta, and management effect score. As in FIG. 7, the individual companies have been sorted based on the management effect score for each company.

In some embodiments, as depicted in FIGS. 7 and 8, the user interface may allow for user 402 to select sectors and/or individual companies as items which should receive particular focus or emphasis in the ensuing analysis. As depicted in FIG. 7, each sector is listed in descending order, sorted from greatest positive management effect score to lowest negative management effect score. Likewise, in FIG. 8, each company is listed in descending order, sorted from greatest positive management effect score to lowest management effect score (i.e. the negative score having the greatest magnitude). As shown, the user interface may include boxes 702, 802 which allow a user 402 to manually select sectors and/or companies as particular areas of focus or emphasis.

In some embodiments, the user 402 may select the sector and/or sectors which had the largest magnitudes of management effect scores (i.e. the biggest contributors and detractors) to receive particular focus or emphasis in the commentary generation process, as an explanation for the performance of the most influential sectors and companies may be required. It will be appreciated that selecting the sectors having the largest magnitudes of management effect scores is merely an example embodiment, and that in other embodiments other sectors may be selected based on factors other than having the highest management effect scores.

Returning to FIG. 4, after attribution table 404 has been processed, and after sectors, sub-sectors and/or companies have been selected for particular emphasis, news search manager 408 may search for and obtain news articles and other news data. In some embodiments, news search manager 408 may use a Generative AI system to perform research. In some embodiments, the GenAI system may be a modified version of the GPT Researcher open-source library.

GPT Researcher is an agent-based system which may generate a set of related research questions from an initial query using an LLM. In some embodiments, the Tavily Search API may be used to create an agent for each research question generated. The search results may then be scraped and summarized. The summaries may then be used to generate a research report. It will be appreciated that in other embodiments, other search mechanisms may be incorporated (e.g., custom retrievers which make use of trusted sources for the organization, such as Bloomberg).

In some embodiments, the GPT Researcher is modified to provide compatibility with an LLM gateway. In some embodiments, the LLM gateway may be internal to an organization. For example, the LLM gateway may be internal to a particular financial institution for which commentary is being generated. Further, in some embodiments, the GPT Researcher may be modified to provide real-time feedback to the front end client 502. In some embodiments, real-time feedback may be provided using Server Sent Events.

In some embodiments, news search manager 408 may be configured to conduct a news search for the benchmark index and/or companies selected for additional emphasis by the user 402. As an example embodiment, for the benchmark index, news search manager 408 may generate an initial search query of “what specific news and world events impacted the performance of the {item} index in {time_period}? ”, where {item} is the benchmark index name, and {time_period} is a date string. In some embodiments, the {time_period} value may be generated from the attribution table 404, and in particular from the date range of the date contained in attribution table 404.

For selected companies and/or selected sectors, news search manager 408 may begin with the search query “what specific news and world events impacted the stock price of {item} in {time_period}? ”, where {item} is the company name, and {time_period} is the same date range used for the benchmark index search. For example, an example search query could be “search for events impacting Nvidia from Jan. 1, 2023 to Dec. 31, 2023”. From this initial query, agents may split the search task into subtasks (such as related queries for events impacting Nvidia, events impacting technology stocks more broadly), and perform searches.

Given that queries will generally be performed for general market information for the benchmark index, specific sectors, and specific companies, the news search manager 408 may then combine the results and summarize the results together. For example, in some embodiments, query results may be combined for a particular item (e.g., for a benchmark, a sector, a company, or the like). FIG. 9 is an example graphical user interface depicting news search results for example benchmarks 602b and companies (as depicted, the MSCI World index, Estee Lauder, First Republic Bank, Microsoft Corp., and NVIDIA Corp.). As depicted, each market benchmark and company's news may be contained within a collapsible dropdown menu 902, which may expand to show contents when clicked.

FIG. 10 depicts an example news summary for a benchmark index (for example, the result of user 402 selecting dropdown button 902 to show the contents for the MSCI World benchmark index 602b). It will be appreciated that this functionality may apply equally to the other companies listed in FIG. 9 when the dropdown button is selected.

In some embodiments, the user interface (as depicted in FIG. 10) may allow for the user 402 to review the news search results, and optionally to select topics or portions of the news search results for particular emphasis in the commentary which will be generated for the investment vehicle. Such selected portions are referred to herein as “key drivers”. In some embodiments, key drivers may be selected, for example, by highlighting portions of the contents of the news search results. For example, as shown in FIG. 11, the user 402 has highlighted a portion of the news search results for the benchmark 602b index relating to global uncertainty and observed consumption. In some embodiments, selecting a portion of the text may trigger news search manager 408 to display a “capture key driver” button 1002 which facilitates user 402 selecting the highlighted text as a key driver which will receive heightened emphasis.

In still other embodiments, the user interface (as depicted in FIGS. 9 and 10) may allow a user 402 to manually enter a key driver topic. For example, if a user or analyst 402 is already aware that oil prices have been at a record high due to geopolitical events, the user may manually enter this topic as a key driver in field 1104. As depicted in FIG. 12, the user 402 has entered a key driver relating to poor performance in the financial sector stemming from fears relating to a mid-size US bank crisis.

In some embodiments, news search manager 408 may be configured to perform automatic updates. For example, news search manager 408 may be configured to poll information from a particular website within backend API 504. In some embodiments, frontend client 502 may be provided with real-time feedback (e.g. to provide an update on the progress of a news search being conducted). Such feedback may improve the user experience (as the user will be aware of the status of a news search while it is being performed).

In some embodiments, recently performed searches by news search manager 408 may be cached. In so doing, the system may be able to utilize recent search results rather than re-performing the same search multiple times, which may benefit overall performance and reduce the processing burden and associated time required. For example, in some embodiments, the SQLite database may generate a unique identifier based on item name and time period for each item extracted from attribution table 404, and generate a cache for that item in the SQLite database. Thus, when front end client 502 requests certain data, it may check to see if such data is already present in SQLite database from a sufficiently recent search. If such data is already present, the need for a new search may be obviated. Otherwise, an agent can be triggered to open a connection using Server Side Events to perform a news search.

Once news searches have been completed, the news content and any key drivers selected or added after the news searches may be transferred to backend API 504. In some embodiments, backend API 504 is configured to take key drivers, and match them to corresponding performance data as part of generating a commentary (e.g. in the form of text data). In some embodiments, not all performance data for all metrics may be provided to backend API 504. For example, depending on the overall benchmark news, there may only be a need to provide management effect scores and relative performance data, without providing all other data (e.g. weightings). The selective inclusion of relevant day may further improve the likelihood of the LLM generating accurate commentary text.

In some embodiments, commentary drafts may be generated by commentary generation block 410. In some embodiments, commentary drafts may be generated using a large language model (LLM) and one or more prompts. In some embodiments, the LLM is GPT-4. In some embodiments, GPT-4 may be accessed via backend API 504 and LLM gateway 506 of the financial institutional.

In some embodiments, prompts for the LLM may be generated based on one or more of performance data for the fund, the sectors 702 selected by user 402, the companies selected 802 by user 402, and/or the key drivers input by the user 402. In some embodiments, the performance data, sectors and/or companies may be converted into JSON dictionaries prior to being incorporated into the LLM prompt.

In some embodiments, the fund performance data may include one or more of the relative performance of the fund compared to the benchmark index, and the management effect score.

In some embodiments, selected sector data may include one or more of the overall performance of a sector, the sector performance relative to the baseline index, the weight position of the sector relative to the benchmark, and the management effect score.

In some embodiments, some numerical values may be converted to string values. For example, the weight position relative to the benchmark may be converted to a string value. For example, rather than using a weight value of “3.21”, a string value (e.g. “overweight”, “underweight”, “slightly overweight”, or “slightly underweight”) may be created using a helper function. In some embodiments, the management effect score may be converted to a string value (e.g. “positive”, “negative”, or “neutral”) using a helper function.

Unexpectedly, it has been found that system performance is significantly improved when replacing relative weight values and/or management effect scores with string values rather than numerical values. For example, LLMs tend to interpret data more accurately when referring to a quantity overweight instead of using a decimal percentage value which might otherwise represent the same concept. In some embodiments, the translation of performance data into text may be based on a combination of the user's understanding of the significance of the value, as well as other values. For example, beyond a metric being positive or negative, the metric may be taken into consideration of a matrix of management effect scores, asset weightings, and performance, which may form a more specific meaning in the financial context of a fund, and may be more easily reframed into the appropriate interpretation by an LLM.

Thus, the use of strings may decrease the likelihood of hallucinations from the LLM, and may ensure that the LLM correctly interprets the relative weight and management effect scores. Numerical representations of overarching sentiment may also be converted to text representations to explain decision-making related to management effect scores.

In some embodiments, news highlights are converted to JSON dictionaries and may be passed along with the fund performance data. In particular, JSON dictionaries may be inserted into the commentary generation prompt prior to being sent to LLM gateway 506.

It will be appreciated that performance of the LLM may be greatly impacted by ensuring the LLM has been properly versed in the terminology that is being provided as an input. In some embodiments, the commentary generation prompt may include an information section, a definitions section, and instructions for writing each section in the commentary.

In some embodiments, the definitions section of the prompt may provide an explanation of the values provided in the performance data. For example, for each value in the attribution table 404, one or more sentences may be provided which explain the meaning of the value and how to interpret it. It has been found that LLMs respond particularly well using JSON as a format, and so in some embodiments a definitions list is provided in JSON format, and performance data may be reformatted to JSON as well.

Optionally, a set of requirements may be provided in the prompt in order to help control the LLM output. In some embodiments, the information section of the prompt might be populated using performance data and news highlights.

In some embodiments, the instructions for writing each section may be based on a particular stylistic preference. For example, instructions for writing a section might include “use standard Canadian Fund commentary” or “use commentary for a large institutional client audience”. In some embodiments, specific instructions may be provided for each section of the generated commentary. In still further embodiments, one or more example paragraphs from an analyst's written commentary may be included with the specific instructions for each section. The use of such example paragraphs reflects a “few-shot” learning approach.

In still other embodiments, prompts may be subdivided into instructing the LLM to generate each separate section (e.g., benchmark, sector, companies) of a commentary document. For example, to generate a summary of fund performance taking benchmark-specific key drivers into account, an example prompt might be “talk about fund performance using news highlights from market news to construct narrative about market performance, and make sure to mention fund's overall performance relative to the benchmark”. In some embodiments, key drivers specific to a particular section may be used for that particular section. Prompts may further include refinements such as specifications of particular tones, particular vocabularies depending on the intended audience, tailoring for regulations of specific countries, and the like.

In still further examples, a prompt might specify generating a paragraph about companies selected using the key drivers selected by the user 402. A further example prompt might instruct the LLM to generate a concluding paragraph with forward-facing news highlights from the news section, and an opinion of the market moving forward.

FIG. 13 is an example user interface depicting a draft commentary document generated by the systems and methods described herein. As depicted, the draft commentary contains content relating to each of the key drivers previously identified, as well as content relating to each of the selected benchmarks, sectors and companies selected by user 402.

In some embodiments, as described below, user 402 may review and revise the generated commentary document. Optionally, user 402 may transmit the final version of the commentary document back to system 126, which may allow system 126 to learn from stylistic revisions made by user 402. For example, system 126 may use edits and/or modifications made/accepted by user 402 as preference signals to refine prompts, refine selection heuristics, and/or refine expansion patterns. In some embodiments, the degree to which edits and/or modifications accepted by user 402 are used as preference signals may be constrained by privacy and governance requirements within the organization.

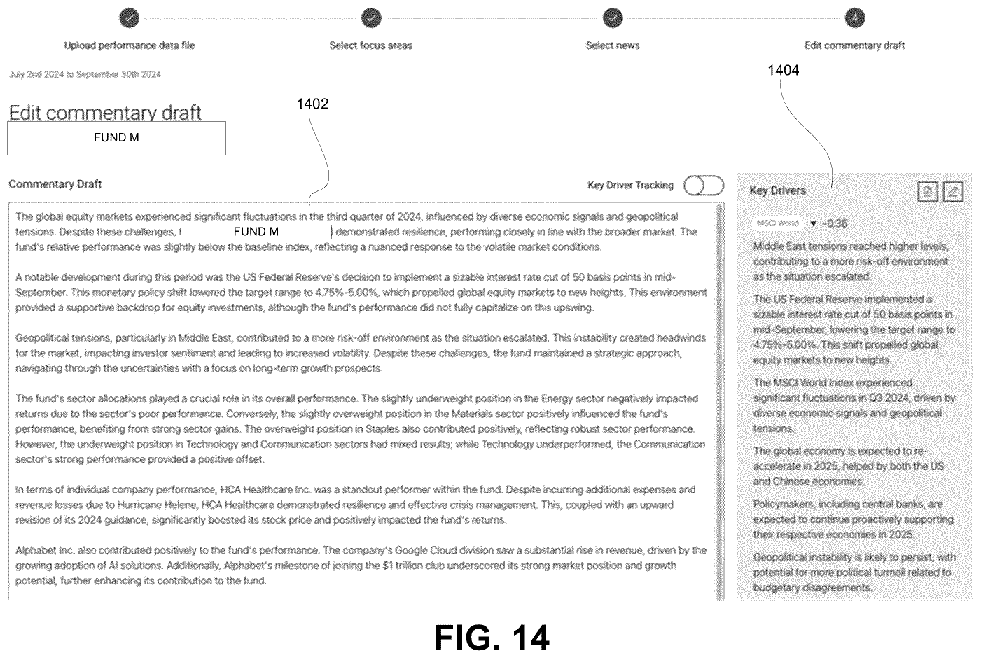

Returning to FIG. 4B, in some embodiments, system 126 may include commentary editing block 412. In some embodiments, commentary editing block is configured to present the generated commentary from block 410 to user 402. In some embodiments, commentary editing block 412 may present generated commentary within a text editing graphical user interface to facilitate enrichment, validation, and/or traceability of the generated commentary. FIG. 14 depicts an example text editor user interface. As depicted, the text editing interface may include a text editor pane 1402, a side panel 1404 (listing, for example, key drivers such as news items, market events, and/or performance data elements). In some embodiments, commentary editing block may be integrated with backend API 504 and/or LLM gateway 506, and may communicate using one or more HTTP methods (e.g., GET, POST, PATCH) and/or Server-Sent Events and/or WebSocket channels.

In some embodiments, commentary editing block 412 may include one or more sub-components. In some embodiments, the sub-components may include a sourcing and citation linker 412a, an expansion manager 412b, a fact-check orchestrator 412c, and/or an auto-save and re-linting manager 412d. In some embodiments, one or more of these sub-components may be implemented as separate processes, threads, microservices, or logical modules within backend API 504.

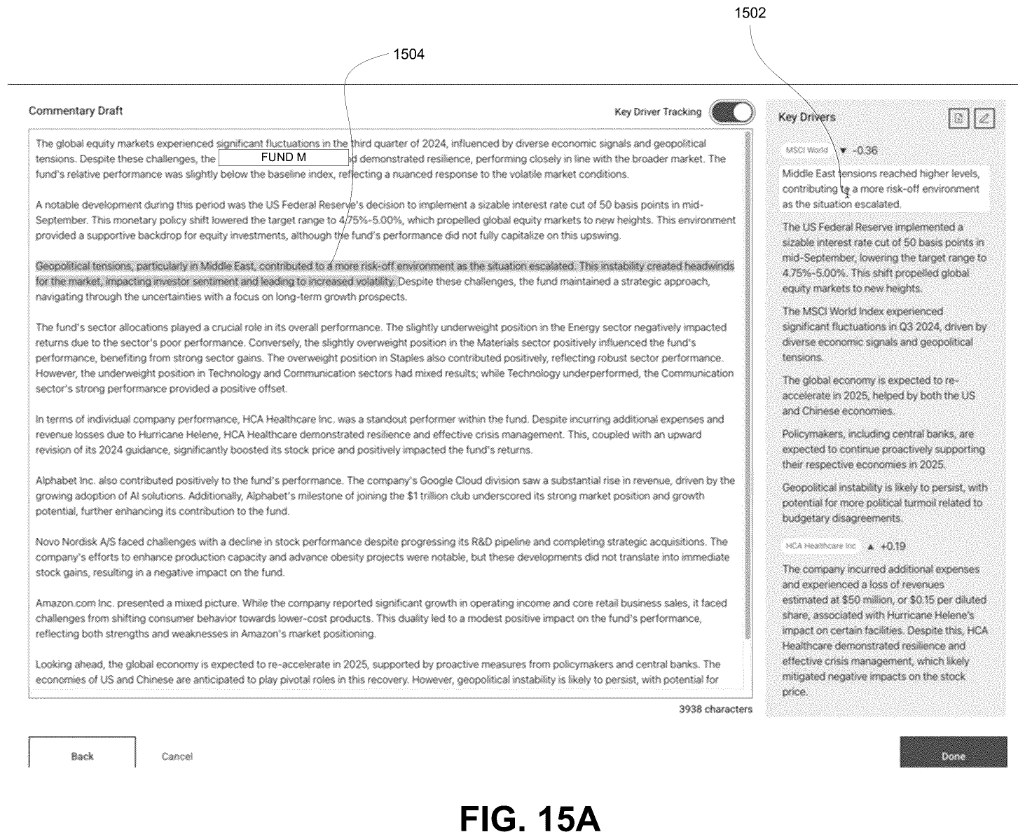

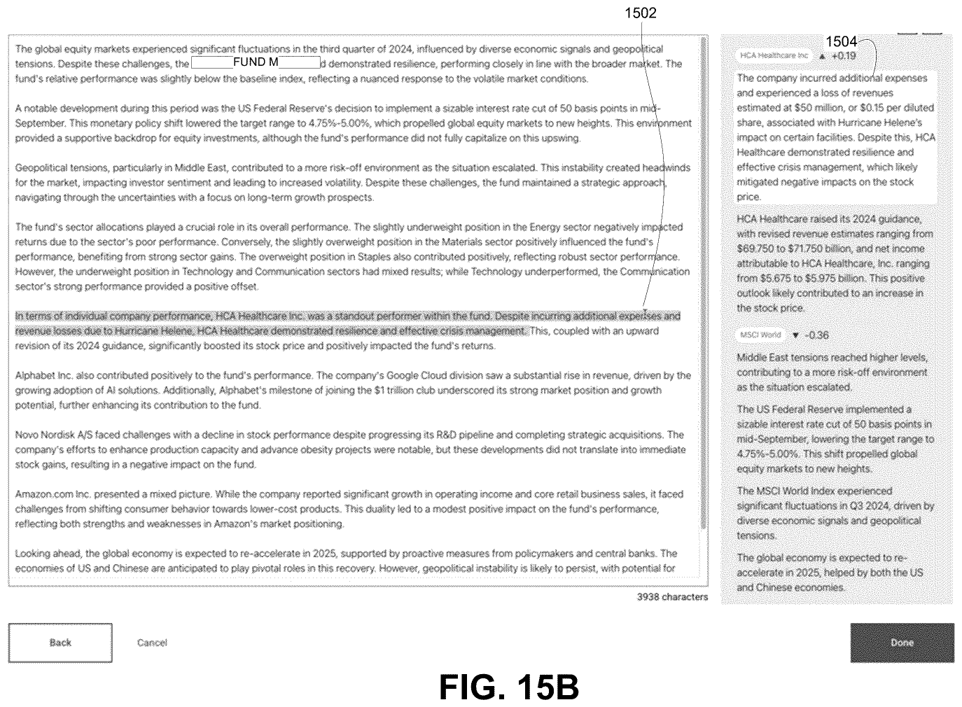

FIG. 15A depicts operations of an example sourcing and citation linker, in accordance with some embodiments. As depicted, the sourcing and citation linker 412a is configured to associate text passages of the generated commentary with one or more underlying key drivers (e.g., news items or market events previously identified during research), and vice versa. For example, as shown in FIG. 15A, when cursor 1502 is hovered over a key driver in key driver pane 1404, the corresponding text (e.g., one or more sentences) in text editor pane 1402 is highlighted. Likewise, as shown in FIG. 15B, when cursor 1502 is hovered over a text passage in text editor pane 1402, the corresponding key drivers 1504 for the text passage are highlighted in side panel 1404.

In some embodiments, sourcing and citation linker 412a operates by invoking an LLM using inputs including, but not limited to, the full commentary text (or the portion of the commentary text), and the complete set of candidate key drivers. For example, the candidate key drivers may be stored as an ordered list in which each entry includes one or more of a driver index, title, source metadata, and optional notes.

In some embodiments, the LLM may be instructed to return a single result (e.g., a single JSON array). In some embodiments, the result may be a JSON array in which each element is an object comprising at least a “sentence” field (e.g., the exact sentence text) and a “key driver indices” field which contains an array of integer indices referencing the supplied key drivers. In this manner, the JSON array may yield a mapping of sentences to the drivers which were most likely to have been used to generate each sentence. In some embodiments, in-line badges may display the linked driver indices adjacent to each sentence. Such badges may function as, for example, a type of footnote or citation.

In some embodiments, associations output by source and citation linker 412a may be stored in a database record. In some embodiments, the associations may be stored as a JSON array. It is contemplated that source and citation linker 412a may be invoked incrementally. That is, linker 412a may be invoked upon initial commentary generation, after user edits, after other tool operations (such as expansion, as described below), such that the linkages between key drivers and the text remain up-to-date with the text.

In some embodiments, commentary editing block 412 includes expansion manager 412b. Expansion manager 412b may be invoked (e.g., on a passage selected by user 402) to return a replacement passage for the selected text which preserves the tone and/or narrative of the original text passage, and incorporates additional specific facts, descriptions, and/or examples. In some embodiments, expansion manager 412b may constrain the LLM with section-specific instructions, as described above, which may facilitate preserving one or more of the tone, reading level, and/or regulatory compliance within sub-portions of the document. Such constraints may further include, for example, limits on length, citation density requirements, and constraints on vocabulary (e.g., avoiding the use of promissory language). In some embodiments, expansion manager 412b may use an LLM to invoke web searches on the public internet and/or internal, private data sources to generate the replacement passage.

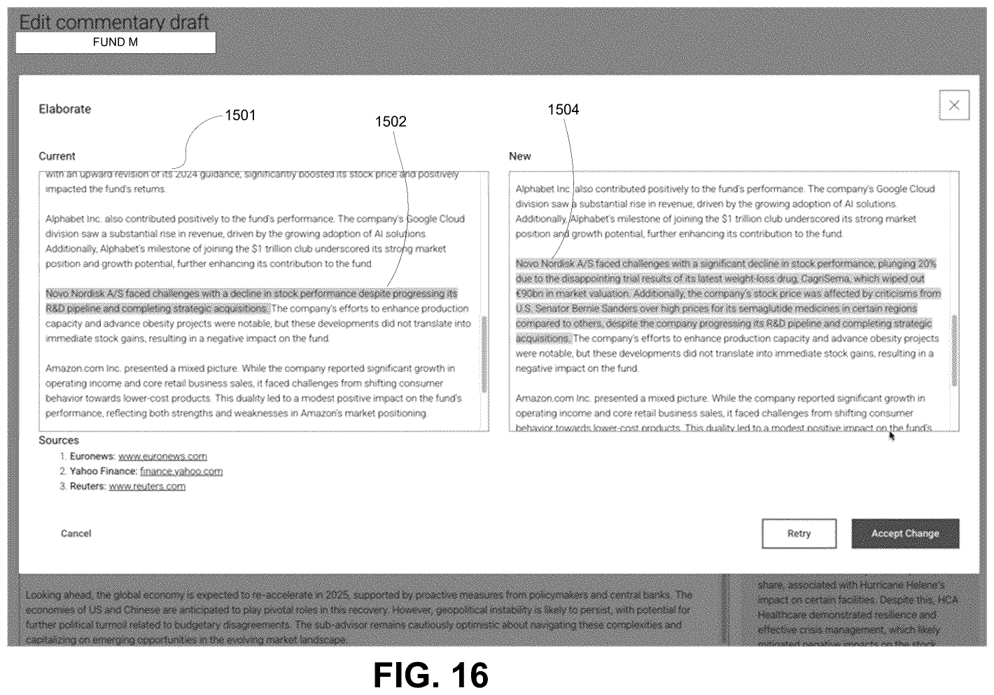

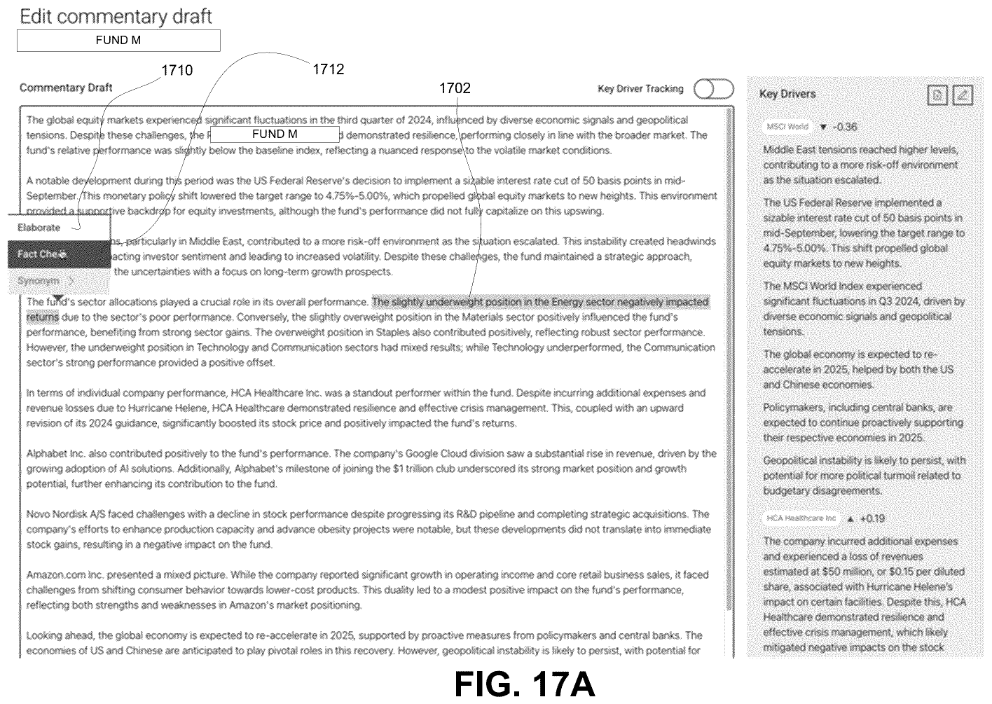

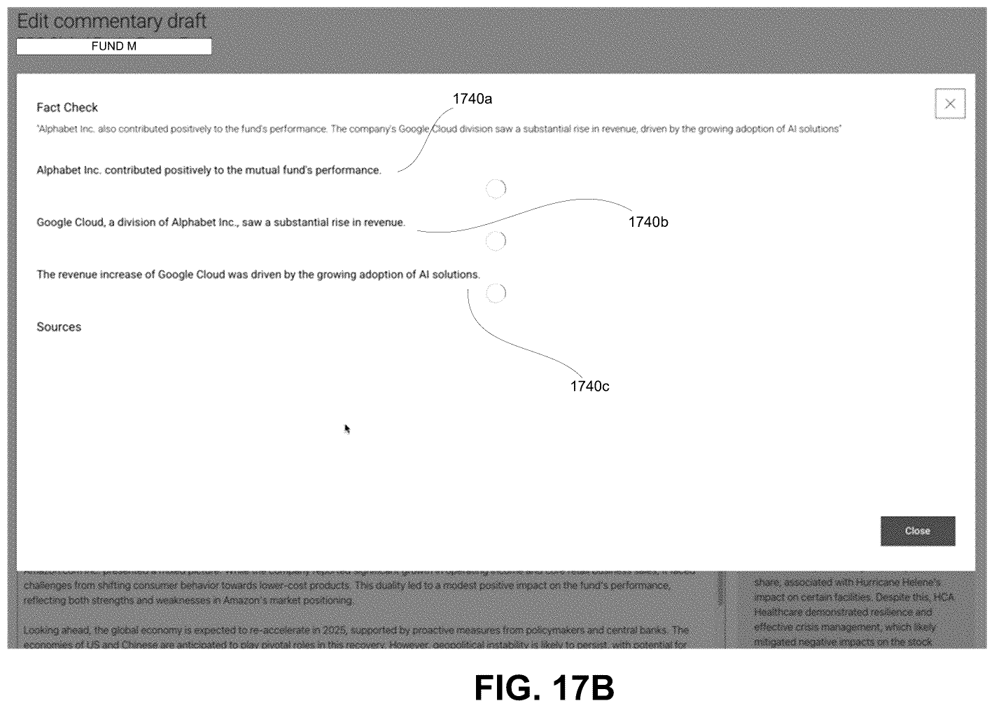

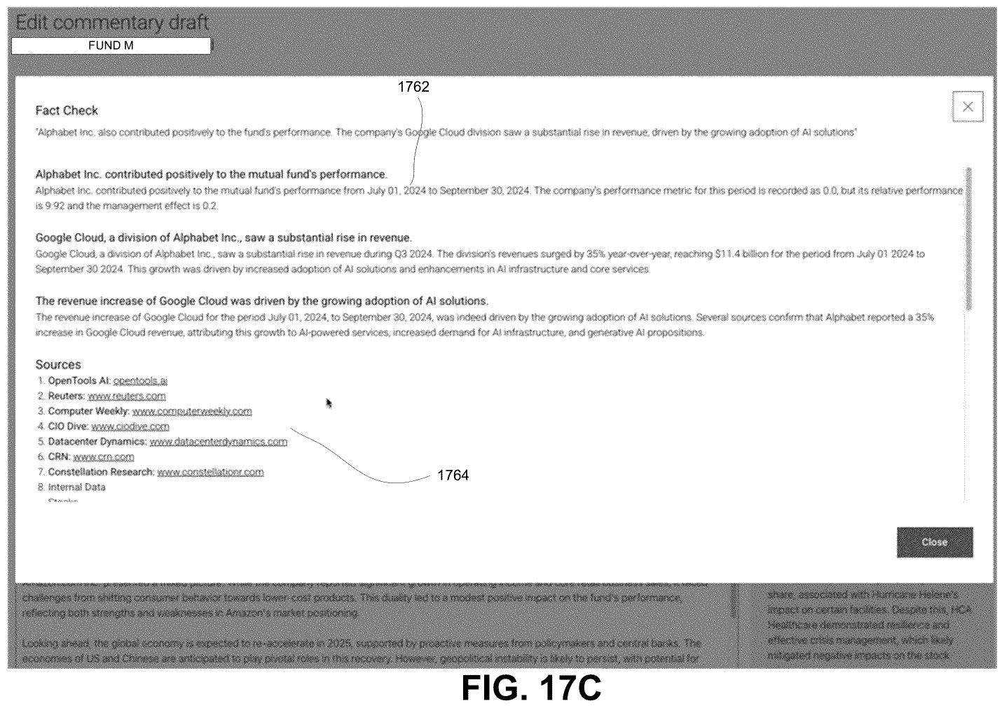

FIG. 16 depicts an example graphical user interface showing both the original commentary text 1501, the selected text passage for expansion 1502, and the resulting replacement passage 1504. In some embodiments, expansion manager 412b may be triggered by the user selecting a text passage and selecting expansion from a drop-down menu (e.g., an ‘elaborate’ button 1710, as depicted in FIG. 17A).

In some embodiments, commentary editing block 412 includes fact-check orchestrator 412c. As depicted in FIG. 17A, a user 402 may select a text passage 1702 and invoke fact-check orchestrator 412c (e.g., via button 1712).

In some embodiments, a fact checking operation may be performed in two distinct stages. A first example stage may be a claim extraction block, in which the selected/highlighted text passage (and/or a larger text passage in which the passage is located, such as a paragraph) may be decomposed into independently verifiable claims. For example, verifiable claims might be in the form of atomic statements which have a clear subject, predicate, and measurable conditions. In some embodiments, the claim extraction block may be performed by an LLM. In some embodiments, the LLM may be instructed or otherwise prompted to avoid overlapping and/or compound claims.

In some embodiments, the second stage includes each claim from the first stage being verified by one or more verification workers. In some embodiments, the claims may be verified in parallel. As depicted in FIG. 17B, a user interface may display a plurality of claims being fact-checked or verified. In some embodiments, each verification worker may be granted controlled access to an agentic web search subsystem (e.g., the research pipeline of news search manager 408), and/or access to structured fund data. For example, structured fund data may include one or more of rows from an attribution table (such as that depicted in FIG. 6B), including but not limited to performance data, sector/weight deltas, management effect scores, and the like.

In some embodiments, a verification worker may retrieve candidate evidence, assess or otherwise score the consistency of the claim with the candidate evidence, and output a verdict (as depicted for example, in FIG. 17C). For example, a verdict might be selected from a group including “verified”, “contradicted”, and “insufficient evidence”. In some embodiments, the verification worker may further include an explanation 1762 for the verdict. In some embodiments, the explanation may include citations 1764 (e.g., URLs, titles, access timestamps, and the like), and/or identifiers of specific rows used from the attribution table and/or fund dataset. In some embodiments, the result of a fact checking operation may be stored as a data object including records for one or more of the claim, the associated fact check task, and the associated fact check result, and/or fields for claim text, evidence pointers, verdicts, rationales, and/or confidence scores.

In some embodiments, commentary editing block 412 includes autosave and re-linting manager 412d. In some embodiments, when a user 402 modifies the generated commentary, autosave and re-linting manager 412d may be configured to trigger source and citation linker 412a. In some embodiments, autosave and re-linting manager 412d may re-invoke linker 412a on the full commentary text using the current key driver list. In some embodiments, re-linting manager 412d may be invoked using a subset of the commentary text (e.g., on the passages which were modified by the user, and/or on the paragraphs containing passages which were modified by the user) as an input, and the current key driver list. In this manner, the output from linker 412 (e.g., a newly returned JSON array) may supersede any prior associations in the previous version of the commentary text, thereby maintaining up-to-date provenance for the current version of the commentary text.

In some embodiment, autosave and re-linting manager 412d is configured to capture and save edits made to the commentary text. In some embodiments, edits may be saved upon any one or more of an explicit user action, closing the document, and/or upon expiration of a period of inactivity (e.g., 1 to 5 seconds of inactivity, although any suitable time threshold may be used). In some embodiments, each instance of saving may trigger a re-linting pipeline which includes one or more of text normalization, sentence boundary detection, and incremental re-linking by linker 412a for passages which have been modified.

In some embodiments, autosave and re-linting manager 412d may create and store a versioned history of the document. In some embodiments, each version of the document may be stored in a record including a document version table, an edit operation table, and a span mapping table which outlines spans of text which were modified). A versioned history may be enable comparisons of different versions, rollbacks to previous versions, and audits to track changes throughout different versions. System 126 may further be configured to mark provenance edges and fact-check results as being “stale” (i.e., as having been performed too long ago in the past, or as having been performed prior to an editing operation), which may prompt re-verification to maintain traceability and accuracy.

In some embodiments, commentary editing block 412 may be entered into automatically after commentary generation block 410 has completed. In some embodiments, commentary editing block 412 may be entered into when a user 402 opens a saved draft. In some embodiments, commentary editing block 412 may re-use cached data from news search manager 408 to reduce or avoid redundant network calls during certain operations (e.g., expansion and/or fact-checking operations). In still other embodiments, commentary editing block 412 may be configured to enforce organization-specific content policies by filtering or annotating suggested content insertions. For example, commentary editing block 412 may be configured to restrict content to approved news sources, and/or to ensure compliance with organization policy documents and other rule sources.

In some embodiments, commentary editing block 412 may be implemented using a background work queue (e.g., asynchronous task runners) for operations expected to be more computationally intensive or longer in duration (e.g., expansion research, batch fact-checking tasks, and the like). In some embodiments, progress updates on such operations may be pushed to the graphical user interface. In some embodiments, updates may be streamed to the user interface via server-sent events. In still other embodiments, cached data may be re-used to streamline repeated evidence look-ups.

In some embodiments, access to editing features (e.g., commentary editing block 412) and/or underlying datasets may be controlled by providing user roles to individual users or classes of users. For example, the ability to approve new external references introduced during an expansion 412b operation might only be provided to user with analyst roles. Likewise, the ability to mark a generated draft as “publishable” might be restricted to users with compliance roles. Moreover, system 126 may be configured to record all edit operations, fact-check runs, and citation updates in audit logs, so as to enable and facilitate auditing.

As noted above, although various example embodiments described herein relate to investment commentary, it is contemplated that some embodiments of systems and methods described herein may be used in other contexts and applied to other document types (e.g., articles, research essays, legal or medical documents, and the like). Moreover, additional constraints may be imposed by commentary editing block 412 dependent on the context. For example, in legal or healthcare contexts, web sources might be restricted to organization-approved repositories, and/or may require dual verification against internal knowledge bases prior to classifying a claim verdict as “verified”.

Of course, the above-described embodiments are intended to be illustrative only and in no way limiting. The described embodiments are susceptible to many modifications of form, arrangement of parts, details, and order of operation. Moreover, features described with respect to any component or sub-component described herein may be combined with features of any other component, omitted, or re-ordered to suit specific deployment requirements and constraints. The invention is intended to encompass all such modifications within its scope, as defined by the claims.

What is claimed is:

1. A method comprising:
receiving an electronic document containing attribution data for an entity;
processing said electronic document to extract data comprising a time period and at least one of a benchmark, a sector, a company, and associated performance data;
displaying, in a graphical user interface, performance data for said time period based on said extracted data;
receiving a selection of at least one of said sectors and/or companies;
performing, using a generative artificial intelligence system, one or more queries for news relevant to said at least one benchmark and selected sectors and/or companies;
summarizing, by said generative AI system, results of said queries;
displaying, in said graphical user interface, said summarized results of said queries;
receiving a selection of at least one topic for emphasis;
generating, by a large language model, a text document comprising commentary relating to said performance data, said benchmark, said selected sectors and/or companies, and said at least one topic for emphasis; and
displaying, in said graphical user interface, said text document.

2. The method of claim 1, wherein said performance data includes at least one of a weighting metric and a management effect metric.

3. The method of claim 2, further comprising converting said at least one weight metric and management effect metric from numerical values to text descriptors.

4. The method of claim 1, wherein said receiving said selection of at least one of said sectors and/or companies comprises a user selecting, in said graphical user interface, said at least one sector and/or company.

5. The method of claim 1, wherein said performing said one or more queries comprises generating an initial query prompt and generating, based on said initial query prompt, a plurality of supplementary search strings.

6. The method of claim 4, wherein said performing said one or more queries comprises performing at least one query for each of said selected sectors and/or companies.

7. The method of claim 1, wherein said receiving said selection of at least one topic for emphasis comprises said user selecting, in said graphical user interface, a portion of text of said summarized results of said queries.

8. The method of claim 1, wherein said generating said text document comprises generating a set of definitions of terms used in said attribution data and transmitting said set of definitions to said large language model.

9. The method of claim 8, wherein said set of definitions is in JSON format.

10. The method of claim 1, further comprising caching said results of said queries.

11. The method of claim 10, wherein caching said results of said queries comprises generating, for each result, a unique identifier based on an item name and said time period and storing each respective result in a database associated with each respective unique identifier.

12. The method of claim 1, wherein said displaying said text document comprises displaying said text document in a text editing interface.

13. The method of claim 12, wherein said text editing interface comprises a source linker configured to associate a selected text passage from said text document with one or more key drivers associated with said selected text passage.

14. The method of claim 12, wherein said text editing interface is configured to receive a selected text passage and generate a replacement text passage having greater detail than said selected text passage.

15. The method of claim 14, further comprising replacing said selected text passage with said replacement text passage; and invoking said source linker to update associations between said replacement text passage and said one or more key drivers.

16. The method of claim 12, wherein said text editing interface is configured to receive a selected text passage and generate a veracity verdict for one or more claims in said selected text passage.

17. The method of claim 16, wherein generating said veracity verdict comprises extracting said one or more claims from said selected text passage and invoking said LLM to generate said veracity verdict and an explanation for said veracity verdict.

18. The method of claim 16, further comprising determining that said selected text passage has been modified; and marking said veracity verdict as stale in response to said determining that said selected text passage has been modified.

19. A system comprising:
a processor; and
a computer-readable storage medium having stored thereon computer-executable instructions that, when executed by said processor, cause the processor to perform a method comprising:
receiving an electronic document containing attribution data for an entity;
processing said electronic document to extract data comprising a time period and at least one of a benchmark, a sector, a company, and associated performance data;
displaying, in a graphical user interface, performance data for said time period based on said extracted data;
receiving a selection of at least one of said sectors and/or companies;
performing, using a generative artificial intelligence system, one or more queries for news relevant to said at least one benchmark and selected sectors and/or companies;
summarizing, by said generative AI system, results of said queries;
displaying, in said graphical user interface, said summarized results of said queries;
receiving a selection of at least one topic for emphasis;
generating, by a large language model, a text document comprising commentary relating to said performance data, said benchmark, said selected sectors and/or companies, and said at least one topic for emphasis; and
displaying, in said graphical user interface, said text document.

20. A computer-readable storage medium having stored thereon computer-executable instructions that, when executed by said processor, cause the processor to perform a method comprising:
receiving an electronic document containing attribution data for an entity;
processing said electronic document to extract data comprising a time period and at least one of a benchmark, a sector, a company, and associated performance data;
displaying, in a graphical user interface, performance data for said time period based on said extracted data;
receiving a selection of at least one of said sectors and/or companies;
performing, using a generative artificial intelligence system, one or more queries for news relevant to said at least one benchmark and selected sectors and/or companies;
summarizing, by said generative AI system, results of said queries;
displaying, in said graphical user interface, said summarized results of said queries;
receiving a selection of at least one topic for emphasis;
generating, by a large language model, a text document comprising commentary relating to said performance data, said benchmark, said selected sectors and/or companies, and said at least one topic for emphasis; and
displaying, in said graphical user interface, said text document.
